(19) United States
(12) Patent Application Publication
(10) Pub. No.: US 2023/0000239 A1
(43) Pub. Date: Jan. 5, 2023

(54) APPARATUS FOR CLEANING A GRILL AND METHOD OF USING THE SAME

(71) Applicant: Proud Grill Company Limited, King City (CA)

(72) Inventor: Paul Cira, Toronto (CA)

(73) Assignee: Proud Grill Company Limited, King City (CA)

(21) Appl. No.: 17/364,113

(22) Filed: Jun. 30, 2021

(51) Int. Cl. A46B 9/00; A47J 37/07; A46B 5/02; A46B 15/00; A47L 13/17; A47L 13/08; A47L 13/34

(52) U.S. Cl. CPC A46B 9/005; A47J 37/0786; A46B 5/02; A46B 15/0081; A47L 13/17; A47L 13/08; A47L 13/34; A46B 2200/3033

(57) ABSTRACT

A kit and method of cleaning a barbeque grill that includes engaging a heat-resistant cloth about a support member of a grill brush; absorbing a quantity of liquid with the heat-resistant cloth; placing the brush with heat-resistant cloth engaged onto previously-heated grill bars of the barbeque grill; generating steam as the quantity of liquid is heated by the grill bars; moving the brush with heat-resistant cloth thereon back and forth along the grill bars; removing food matter and grease from the grill bars; and transferring the removed food matter and grease to the heat-resistant cloth. The removal of food matter and grease is accomplished by a combination of the generated steam and the moving of the brush with heat-resistant cloth thereon back and forth along the grill bars. After use, the heat-resistant cloth is disengaged from the brush and may be washed and reused one or more times.

### TECHNICAL FIELD

This disclosure is directed to equipment for use with barbeque grills. In particular the disclosure relates to a tool for removing grease and food remnants from a barbeque grill. Specifically, the disclosure relates to a kit for steam cleaning a barbeque grill that includes a brush, a heat resistant cloth that is engageable with the brush, and a dipping tray for moistening the cloth, and to a method of utilizing the kit to steam clean a barbeque grill.

### BACKGROUND

### Background Information

When food is cooked on a barbeque grill it is common for pieces of the food to become stuck on the surface of the grill. The grill also tends to become coated in grease. It is desirable to remove this stuck food and grease from the grill surface before cooking the next meal thereon. Wire brushes and scrapers were typically used to try and remove these stuck materials from the grill's surface. In recent years people became aware that some traditional grill-cleaning tools tend to shed small pieces of metal. These small pieces of metal tend to become embedded in the grease and food stuck on the grill bars and can be transferred to uncooked food placed on the grill bars. These metal pieces may then be inadvertently ingested and cause injury to people who eat food cooked on the grill. A variety of non-metal barbeque cleaning tools have therefore been proposed by the art to avoid this issue.

Regardless of the tool used to clean barbeque grills, whether metal or non-metal in construction, it remains a problem to adequately remove food pieces and grease from grill surfaces.

### SUMMARY

The barbeque cleaning kit and method of using the same disclosed herein provides a way to more adequately remove food remnants and grease from barbeque grills. The kit for cleaning a barbeque grill includes a grill brush having a base, a handle extending upwardly from the base, and a support member extending downwardly from the base; a heat-resistant cloth which is releasably engageable about the support member of the grill brush; and a dipping tray adapted to retain a quantity of liquid therein.

In one aspect, an exemplary embodiment of the present disclosure may provide a method of cleaning a barbeque grill comprising engaging a heat-resistant cloth about a support member of a grill brush; absorbing a quantity of liquid with the heat-resistant cloth; placing the grill brush with heat-resistant cloth engaged therewith onto previously-heated grill bars of the barbeque grill; generating steam as the quantity of liquid is heated by the grill bars; moving the grill brush with heat-resistant cloth engaged therewith back and forth along the grill bars; removing food matter and grease from the grill bars; and transferring the removed food matter and grease to the heat-resistant cloth.

In one embodiment, the removal of food matter and grease is accomplished by a combination of applying the generated steam to the food matter and grease and moving the grill brush with heat-resistant cloth engaged therewith back and forth along the grill bars. In one embodiment, the method further comprises disengaging the heat-resistant cloth from the grill brush. In one embodiment the method further includes washing the disengaged heat-resistant cloth. In one embodiment, the method further includes reusing the washed cloth at least one further time in a steam cleaning operation.

In another aspect, an exemplary embodiment of the present disclosure may provide a kit for cleaning a barbeque grill comprising a grill brush having a base, a handle extending upwardly from the base, and a support member extending downwardly from the base; a heat-resistant cloth which is releasably engageable about the support member of the grill brush; and a dipping tray adapted to retain a quantity of liquid therein.

In one embodiment, the heat-resistant cloth in the kit is fabricated from an aramid fiber. In one embodiment, the heat-resistant cloth includes silicone nodules on at least an outer surface thereof.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 is a diagrammatic view of a kit for cleaning barbeque grills in accordance with an aspect of the present disclosure, where the kit includes a grill brush with scraper, a heat-resistant cleaning cloth, and a dipping tray;

FIG. 2 is a side elevation view of the grill brush of the kit being used to scrape food particles from a grill bar with the scraper thereof;

FIG. 3A is a top, front, left side perspective view of the grill brush being positioned on an inner surface of the cleaning cloth of the kit prior to engaging the cloth with the grill brush;

FIG. 3B is a top, front, left side perspective view showing the cleaning cloth wrapped around the base of the grill brush and being secured thereto;

FIG. 4A is a top, front, left side perspective view of the grill brush, with cleaning cloth engaged, positioned to be dipped in water contained in the dipping tray of the kit;

FIG. 4B is a top, front, left side perspective view of the grill brush, with cleaning cloth engaged, being dipped in the water contained in the dipping tray;

FIG. 5 is a top, front, left side perspective view of the water-dipped grill brush being used to steam clean a dirty barbeque grill; and

FIG. 6 is a flowchart relating to a method of steam cleaning a barbeque grill with the kit.

Similar numbers refer to similar parts throughout the drawings.

### DETAILED DESCRIPTION

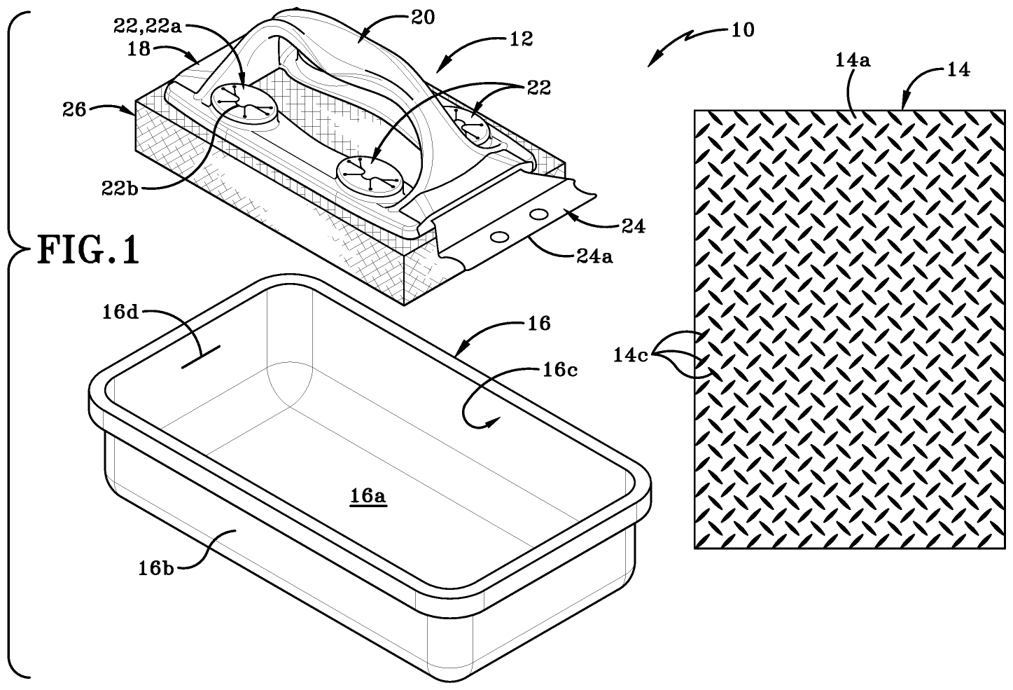

Referring to FIG. 1, there is shown a barbeque grill cleaning kit in accordance with the present disclosure, wherein the kit is generally indicated at 10. Barbeque grill cleaning kit 10 (hereafter “kit 10”) comprises a grill brush 12, a heat-resistant grill-cleaning cloth 14, and a dipping tray 16. Each of these components of kit 10 will be described hereafter in greater detail.

Grill brush 12 comprises a base 18 that includes a handle 20 extending upwardly and outwardly therefrom. Base and handle may be integrally molded from a suitable material such as plastic. The handle 20 is ergonomically shaped so that it is comfortable for a user to grip in their hand.

A plurality of fastener elements 22 are molded as part of base 18. The fastener elements 22 may be in the form of gripping members that are molded into an upper surface of the base. As will be described later herein, the fastener elements 22 are utilized to secure cloth 14 to brush 12. A first set of fastener elements 22 is located on a first side of the handle 20 and a second set of fastener elements 22 is located on a second side of the handle 20. As illustrated, base is provided with four fastener elements 22 that are both laterally and longitudinally spaced from one another on base 18. Each fastener element 22 has an upper surface 22a which defines a specially-configured slit 22b therein. The purpose of slit 22b will be discussed later herein.

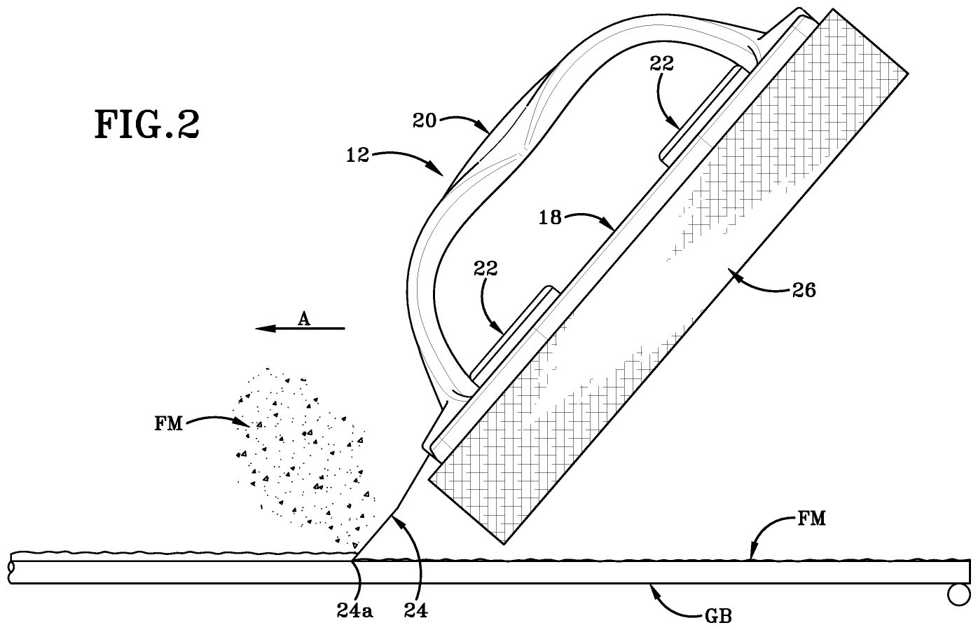

A scraper 24 extends outwardly and forwardly from one end of base 18. Scraper 24 is fabricated from a metal plate and is secured to base 18 in any suitable manner. As best seen in FIG. 2, scraper 24 angles downwardly and forwardly away from the end of base 18 and presents a relatively sharp leading edge 24a that is useful for removing food particles and grease from grill bars “GB” (FIG. 2).

Brush 12 further comprises a support member 26 which is secured to a bottom surface of base 18 in any suitable manner. Support member 26 may be a scouring pad that presents an exterior texture suitable to fictionally engage and secure the fabric of cleaning cloth 14 thereon.

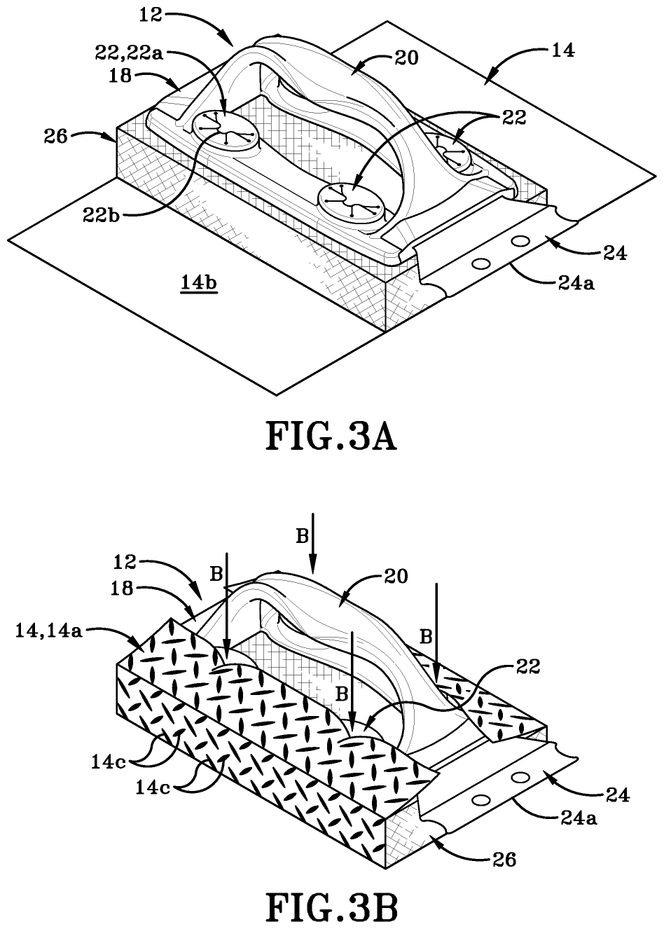

Heat resistant cloth 14 comprises a base layer that has an outer surface 14a and an inner surface 14b (FIG. 3A). The base layer may be fabricated from any suitable heat-resistant material. In one embodiment, a suitable material for base layer a heat-resistant, strong synthetic fiber, particularly an aramid fiber with high strength. One suitable material for base layer is a KEVLAR® aramid fiber material. (KEVLAR® is a registered trademark of E. I. Du Pont De Nemours And Company of Wilmington, Del., USA.) It will be understood, however, that other suitable types of fibrous materials may be utilized in the base layer.

In one embodiment, a plurality of nodules 14c may be provided on the base layer. In one embodiment, the plurality of nodules 14c is provided only on the outer surface 14a of the cloth 14 but it will be understood that in other embodiments, nodules 14a may be provided on both the outer surface 14a and inner surface 14b of the base layer. Nodules 14c are bonded to the base layer and project outwardly for a short distance therefrom. The nodules 14c preferably are arranged at different angles relative to one another or include regions arranged at different angles from one another. Nodules 14c may further be arranged in a pattern on base layer. One suitable pattern in illustrated in FIG. 1. Nodules 14c may be fabricated from any suitable material such as silicone. The materials to form nodules 14c may be heated and deposited onto outer surface 14a of base layer and then the material is allowed to cool and thereby become bonded to the base layer. In other embodiments, the nodules 14c may be bonded to the fibrous material of the base layer using a suitable adhesive or the nodules 14c may be embedded within the fibrous material when the base layer is formed. It will be understood that while the heat resistant cloth 14 is illustrated in FIG. 1 as including silicone nodules, in other embodiments the heat resistant cloth 14 does not include any type of nodule thereon.

Dipping tray 16 is shaped and sized to be slightly larger than the support member 26 of brush 12. Dipping tray 16, for example, may be fabricated from plastic material and, as shown in FIG. 1, includes a bottom wall 16a and a peripheral side wall 16b that extends upwardly and outwardly from a perimeter of the bottom wall 16a. Bottom wall 16a and peripheral side wall 16b bound and define an interior cavity 16c that is suitable to receive the support member 26 of brush 12 therein. Dipping tray 16 is used to hold a volume of liquid “L” within the interior cavity 16c. A fill-line 16d is provided on an interior surface of the peripheral side wall 16b. Fill-line 16d indicates to the user a maximum fill level for placing a maximum volume of liquid “L” into the dipping tray 16. If too much liquid “L” is placed in the dipping tray 16, i.e., if the user places a volume of liquid “L” therein to over fill-line 16d, then when brush 12 with the engaged heat-resistant cloth 14 is dipped into the dipping tray 16, the liquid “L” will tend to flow over the uppermost edge of the peripheral side-wall 16b. The fill-line 16d also indicates to the user a desirable volume of liquid “L” to place into dipping tray 16 to accomplish a steam-cleaning operation for a typical barbeque grill.

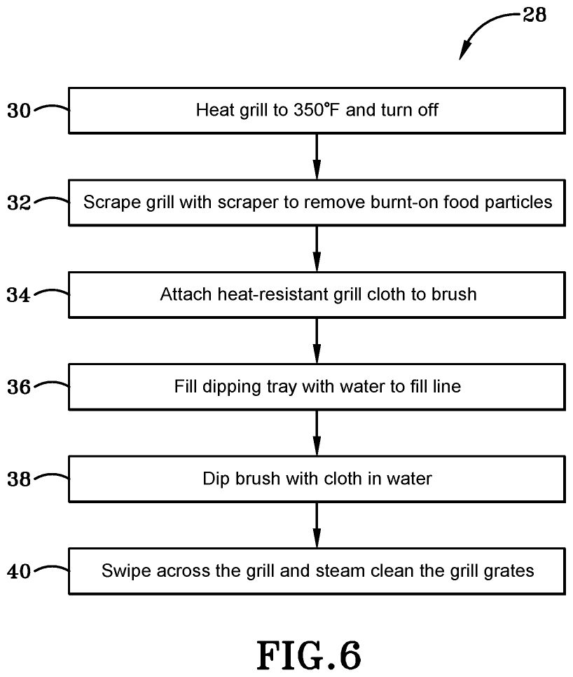

Referring to FIGS. 2 through 6 a method of using kit 10 is illustrated. The method, indicated by the reference character 28 in FIG. 6, includes a plurality of steps. In a first step 30, the barbeque is switched on and the grill is heated to a temperature of about 350° F. (about 175° C.). The grill is then switched off. In a second step 32, brush 12 is used to scrape the grill bars “GB” to remove any burnt-on food particles. This is illustrated in FIG. 2 which shows the brush 12 oriented at an angle to bring the edge 24a of the scraper 24 into contact with the grill bars “GB”. The brush 12 is moved along the grill bars “GB” in the direction of arrow “A” while keeping the edge 24a of scraper 24 in contact with grill bars “GB”. The edge 24a scrapes at least some of the material (burnt-on food and grease) from the grill bars “GB”. The figure shows this scraped-off food matter “FM” flying off the grill bars “GB”. As is evident from the figure, some food matter “FM” is not able to be removed with the scraper 24.

In a third step 32 (FIG. 6), illustrated in FIGS. 3A and 3B, the heat-resistant cloth 14 is attached to brush 12. This is accomplished by the user turning cloth 14 over on a flat surface so that the inner surface 14b is facing upwardly. The brush 12 is moved to a position over a central region of the inner surface 14b of cloth 14 and is moved downwardly to place the support member 26 thereof in direct contact with inner surface 14b. As is evident from FIG. 3A, a region of cloth 14 lays on either side of the support member 26. These regions of the cloth 14 are folded upwardly over a portion of the top surface of the support member 26 and over a portion of the base 18 of the brush 12. Using their index finger, for example, the user will push downwardly on the portions of the cloth 14 which overlay each of the fastener elements 22. The downward pushing force on the fastener elements 22, indicated by arrows “B” in FIG. 32A, causes a deflection in part of the top 22a of the respective fastener element 22. This deflection causes the slit 22b in the fastener element 22 to open up slightly. Some of the cloth 14 is forced to enter into an interior space located beneath the top 22a of the fastener element 22 as the slit 22b opens up and the user's finger continues to push downwardly. The user will then lift his or her finger off the top 22a of fastener element 22. This allows the deflected part of the top 22a to return to its original position, closing the slit 22b, and thereby grippingly engaging part of the cloth 14 therein. When this process is repeated on all four of the fastener elements 22, the cloth 14 is tightly retained around an exterior surface of support member 26.

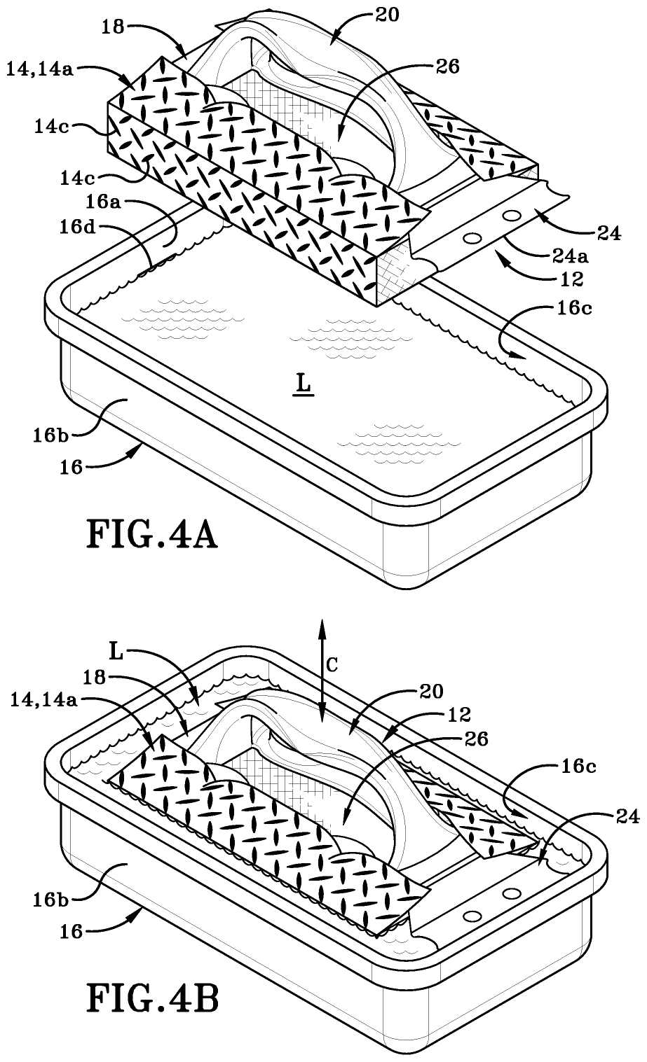

In a fourth step 36 (FIG. 6), a quantity of liquid “L” (FIG. 4A), such as water, is placed in the dipping tray 16. In a fifth step 38 (FIG. 6), the brush 12, with grill cloth 14 engaged therewith is lowered into the liquid “L” of the dipping tray 16. The user will hold brush 12 in dipping tray 16 until a quantity of the liquid “L” soaks into cloth 14. The user will then remove the brush 12 with engaged cloth 14 from within the liquid “L” retained in dipping tray 16. The dunking motion of the brush 12 and engaged cloth 14 into dipping tray 16 is indicated by arrow “C” in FIG. 4B.

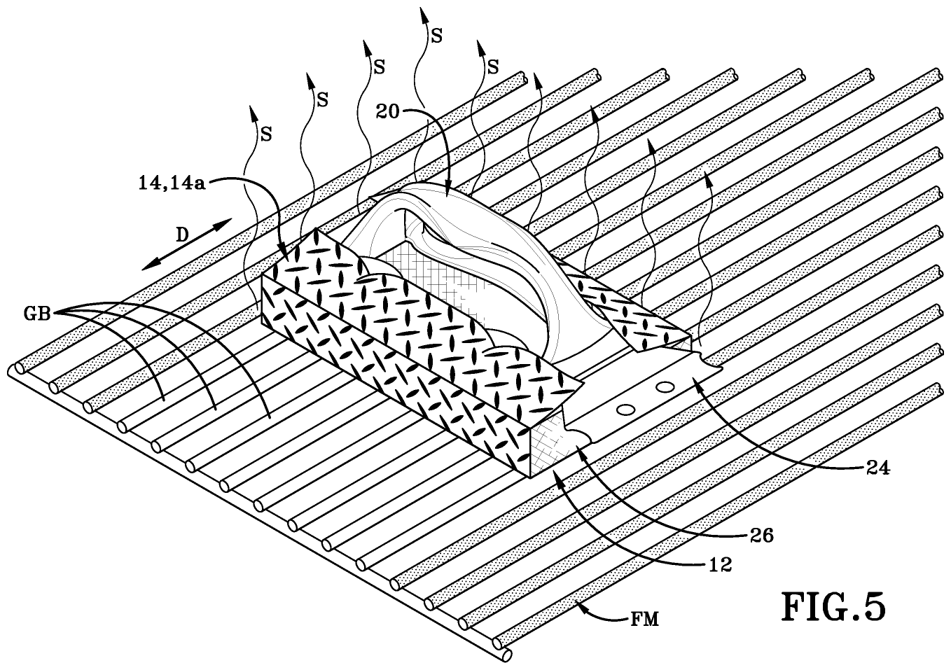

In a sixth step 40 (FIG. 6), the user will substantially immediately place the brush 12 with engaged cloth 14 onto the previously heated grill bars “GB”. This is shown in FIG. 5. Holding handle 20, the user will move the brush 12 with engaged cloth 14 back and forth along the previously-heated grill bars “GB” as indicated by arrow “D” in FIG. 5. The heat from the metal grill bars “GB” will heat the water retained in the cloth 14, created steam “S”. As the brush 12 with engaged cloth 14 is moved back and forth along the grill bars “GB”, the generated steam “S” will penetrate the built-up food matter “FM” that remains on the grill bars “GB”. The steam “S” in conjunction with the brushing motion will loosen and lift the food matter “FM” from off the grill bars “GB”. The lifted food matter “FM” will then be transferred to the part of the cloth 14 that is in contact with the grill bars “GB”, leaving cleaner grill bars “GB” behind. This is illustrated in FIG. 5.

It will be understood that the user may dunk the brush 12 with engaged cloth 14 back into the liquid “L” in the dipping tray 16 several times as needed in order to clean the grill bars “GB”. If needed, the user may also switch the barbeque back on (as in step 32) to heat the same back up to a temperature of about 350° and then repeat steps 38 and 40 of the method 28 as many times as is needed.

When all the grill bars “GB” are deemed clean enough by the user, the cloth 14 is removed from around the brush 12. In particular, the cloth 14 is pulled upwardly to release the parts thereof from their gripping engagement with slits 22b defined in fastening elements 22.

In some embodiments, cloth 14 is rinsed after use and then may be placed in a dishwasher to clean all the removed food matters “FM” thereon from the cloth 14. The cloth 14 is allowed to dry and the brush 12 and folded cloth 14 can then be stored in the emptied (and cleaned) dipping tray 16 until it is next required. The same cloth 14 may be used for about ten to fifteen steam cleaning operations before it needs to be thrown out.

If the cloth 14 is fabricated from KEVLAR® aramid fibers with silicone nodules 14c described earlier herein, then the same cloth 14 may be used for about ten to fifteen steam cleaning operations before the cloth needs to be thrown out. Essentially, the cloth should be replaced when the silicone nodules 14c have been worn flat through use.

It will be understood that in other embodiments, cloth 14 may be disposed of after a single use.

In summary, the method 28 of the present disclosure includes engaging a heat-resistant cloth 14 about a support member 26 of a grill brush 12; absorbing a quantity of liquid “L” with the heat-resistant cloth 14; placing the brush 12 with heat-resistant cloth 14 engaged therewith onto previously-heated grill bars “GB” of the barbeque grill; generating steam “S” as the quantity of liquid “L” absorbed by the cloth 14 is heated by the grill bars “GB”; moving the brush 12 with heat-resistant cloth 14 thereon back and forth (as indicated by arrows “D” along the grill bars “GB”; removing food matter “FM” and grease from the grill bars “GB”; and transferring the removed food matter “FM” and grease to the heat-resistant cloth 14.

The removal of food matter “FM” and grease is accomplished by a combination of the generated steam “S” and the moving of the brush 12 with heat-resistant cloth 14 thereon back and forth along the grill bars “GB”. The method further comprises disengaging the heat-resistant cloth 14 from the brush 12. After disengaging the cloth 14, the method further includes washing the disengaged heat-resistant cloth 14 and thereby removing the transferred food matter “FM” and grease from the heat-resistant cloth 14. The washing of the disengaged heat-resistant cloth 14 includes placing the heat-resistant cloth 14 in a dishwasher. The method further includes reusing the heat-resistant cloth 14 for a further barbeque grill cleaning operation. The heat-resistant cloth 14 may be re used once or up to about fifteen times. The cloth 14 may then be disposed of and a new removable heat-resistant cloth may be engaged with the brush 12. The user can determine whether the heat-resistant cloth is able to be reused by examining the nodules 14c on the cloth 14. When the nodules 14c are worn down to such a degree that they no longer are able to aid in scraping food matter “FM” from the grill bars “GB” then the cloth 14 should be thrown away.

The method includes providing an aramid fiber cloth as the heat-resistant cloth 14. The method further includes securing the heat-resistant cloth 14 on the support member 26 of the brush 12 in such a way that the cloth 14 will contact the grill bars “GB” of the barbeque grill during a cleaning operation. The placing of the brush 12 with heat-resistant cloth 14 engaged therewith onto the previously-heated grill bars “GB” of the barbeque grill is preceded by heating the barbeque to a temperature of about 350° F. and then switching off the barbeque prior to placing the brush 12 with heat resistant cloth 14 engaged onto the grill bars “GB”.

The step of absorbing the quantity of liquid with the heat-resistant cloth 14 is accomplished by providing a dipping tray 16; placing a volume of liquid “L” into the interior cavity 16c of the dipping tray 16; dipping the brush 12 with heat-resistant cloth 14 engaged into the volume of liquid “L”; retaining the brush 12 with heat-resistant cloth 14 engaged in the volume of liquid “L” for a period of time (such as between 30 seconds and 1 minute); and absorbing the quantity of liquid from the volume of liquid “L” in the dipping tray 16. The placing of the volume of liquid “L” into the dipping tray 16 includes filling the dipping tray 16 with liquid up to a fill-line 16d provided on an interior surface of a peripheral side wall 16b of the dipping tray 16. The absorbing of the quantity of liquid with the heat-resistant cloth 14 is preceded by scraping food matter “FM” and grease from the grill bars “GB” with a scraper 24 provided on the brush 12.

In one embodiment, the method may include discarding the heat-resistant cloth 14 after a single use.

In the method 28, the engaging of the heat-resistant cloth 14 about the support member 26 of the brush 12 is accomplished by placing the heat-resistant cloth, outer side 14a down on a support surface; placing a bottom surface of the support member 26 onto an inner side 14b of the heat-resistant cloth 14 (as illustrated in FIG. 3A); wrapping parts of the cloth 14 over side surfaces and a portion of a top surface of the support member 26; securing the wrapped parts of the cloth 14 in place with a plurality of fastener elements 22 provided on the brush 12. The securing of the wrapped parts of the cloth includes using finger pressure to deflect a top surface 22a of each fastener element 22 of the plurality of fastener elements 22 downwardly; opening a slit 22b defined in the deflected top surface 22a; pushing a portion of the heat-resistant cloth 14 through the opened slit 22b; releasing the finger pressure; and grippingly engaging the portion of the heat-resistant cloth 14 as the top surface 22a of the fastener element 22 returns to an undeflected position.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A method of cleaning a barbeque grill comprising:
engaging a heat-resistant cloth about a support member of a grill brush;
absorbing a quantity of liquid with the heat-resistant cloth;
placing the grill brush with heat-resistant cloth engaged therewith onto previously-heated grill bars of the barbeque grill;
generating steam as the quantity of liquid is heated by the grill bars;
moving the grill brush with heat-resistant cloth engaged therewith back and forth along the grill bars;
removing food matter and grease from the grill bars; and
transferring the removed food matter and grease to the heat-resistant cloth.

2. The method according to claim 1, wherein the removing of food matter and grease is accomplished by a combination of applying the generated steam to the food matter and grease and moving the grill brush with heat-resistant cloth engaged therewith back and forth along the grill bars.

3. The method according to claim 1, further comprising:
disengaging the heat-resistant cloth from the grill brush.

4. The method according to claim 3, further comprising:
washing the disengaged heat-resistant cloth; and
removing the transferred removed food matter and grease from the heat-resistant cloth.

5. The method according to claim 4, wherein the washing of the disengaged heat-resistant cloth includes placing the heat-resistant cloth in a dishwasher.

6. The method according to claim 4, further comprising reusing the heat-resistant cloth for a further barbeque grill cleaning operation.

7. The method according to claim 6, comprising reusing the heat-resistant cloth up to about fifteen times.

8. The method according to claim 6, wherein the reusing of the heat-resistant cloth occurs until nodules provided on the heat-resistant cloth are substantially worn down.

9. The method according to claim 1, further comprising providing an aramid fiber cloth as the heat-resistant cloth.

10. The method according to claim 9, further comprising:
securing the heat-resistant cloth on the support member of the grill brush.

11. The method according to claim 1, wherein the placing of the grill brush with heat-resistant cloth engaged therewith onto the previously-heated grill bars of the barbeque grill is preceded by heating the barbeque grill to a temperature of about 350° F.

12. The method according to claim 11, further comprising switching off the barbeque grill prior to placing the grill brush with heat resistant cloth engaged therewith onto the grill bars.

13. The method according to claim 1, wherein the absorbing of the quantity of liquid with the heat-resistant cloth is accomplished by:
providing a dipping tray;
placing a volume of liquid into the dipping tray;
dipping the grill brush with heat-resistant cloth engaged therewith into the volume of liquid;
retaining the grill brush with heat-resistant cloth engaged therewith in the volume of liquid for a period of time; and
absorbing the quantity of liquid from the volume of liquid in the dipping tray with the heat-resistant cloth.

14. The method according to claim 13, wherein the placing of the volume of liquid into the dipping tray includes filling the dipping tray with liquid up to a fill-line provided on a peripheral side wall of the dipping tray.

15. The method according to claim 3, further comprising discarding the heat-resistant cloth after a single use.

16. The method according to claim 1, wherein the absorbing of the quantity of liquid with the heat-resistant cloth is preceded by scraping food matter and grease from the grill bars with a scraper provided on the grill brush.

17. The method according to claim 1, wherein the engaging of the heat-resistant cloth about the support member of the grill brush is accomplished by:
placing the heat-resistant cloth, outer side down, on a support surface;
placing a bottom surface of the support member onto an inner side of the heat-resistant cloth;
wrapping parts of the heat-resistant cloth over side surfaces and a portion of a top surface of the support member;
securing the wrapped parts of the heat-resistant cloth in place with a plurality of fastener elements provided on the grill brush.

18. The method according to claim 17, wherein the securing of the wrapped parts of the heat-resistant cloth includes:
using finger pressure to deflect a top surface of each fastener element of the plurality of fastener elements downwardly;
opening a slit defined in the deflected top surface;
pushing a portion of the heat-resistant cloth through the opened slit;
releasing the finger pressure; and
grippingly engaging the portion of the heat-resistant cloth as the top surface returns to an undeflected position.

19. A kit for cleaning a barbeque grill comprising:
a grill brush having a base, a handle extending upwardly from the base, and a support member extending downwardly from the base;
a heat-resistant cloth which is releasably engageable about the support member of the grill brush; and
a dipping tray adapted to retain a quantity of liquid therein.

20. The kit as defined in claim 19, wherein the heat-resistant cloth is fabricated from an aramid fiber.
